(19) United States
(12) Patent Application Publication
(10) Pub. No.: US 2019/0147828 A1
(43) Pub. Date: May 16, 2019

(54) DISPLAY DEVICE, CONTROL METHOD, AND NON-TRANSITORY COMPUTER-READABLE RECORDING MEDIUM

(71) Applicant: SHARP KABUSHIKI KAISHA, Sakai City (JP)

(72) Inventor: HIROKI ONOUE, Sakai City (JP)

(21) Appl. No.: 16/184,776

(22) Filed: Nov. 8, 2018

(30) Foreign Application Priority Data
Nov. 10, 2017 (JP) 2017-217073

(51) Int. Cl. G09G 5/00; G09G 3/20

(52) U.S. Cl. CPC G09G 5/003; G09G 3/2092

(57) ABSTRACT

A display device is provided with a display panel and a controller. The display panel displays an image. When a distance between a moving body able to move and be still and the display panel is a first threshold or less, the controller controls the display panel such that at least a part of the display panel is see-through.

### BACKGROUND

### 1. Field

The present disclosure relates to a display device, a control method, and a non-transitory computer-readable recording medium.

### 2. Description of the Related Art

The display system described in Japanese Unexamined Patent Application Publication (Translation of PCT Application) No. 2014-503835 is provided with a showcase, a display module, and a human detection unit. The human detection unit detects whether or not a human exists as a moving body. The display module is attached to an opening in the showcase, and functions as a door. The display module includes a transparent display panel. The transparent display panel displays an image. Additionally, when no person is present near the showcase, the transparency of the transparent display panel is raised to make foods arranged inside the showcase easier to see.

However, with the display system described in Japanese Unexamined Patent Application Publication (Translation of PCT Application) No. 2014-503835, if a person is present near the showcase, the image remains displayed on the transparent display panel.

Consequently, in the case in which a human being approaches the transparent display panel, the image may get in the way and make it difficult to see the foods arranged inside the showcase. In other words, in the case in which a human being approaches the display panel from the front side of the transparent display panel, it may become difficult to see an object positioned on the back side of the display panel.

Accordingly, it is desirable to provide a display apparatus, a control method, and a non-transitory computer-readable recording medium making it easier for a human being to see an object positioned on the back side of a display panel when the human being acting as a moving body approaches the display panel from the front side.

### SUMMARY

According to a first aspect of the present disclosure, there is provided a display device including a display panel and a controller. The display panel displays an image. The controller controls the display panel when a distance between a moving body able to move and be still and the display panel is a first threshold or less, such that at least a part of the display panel is see-through.

According to a second aspect of the present disclosure, there is provided a control method including: determining whether or not a distance between a moving body able to move and be still and a display panel is a threshold or less; and controlling the display panel when the distance is determined to be the threshold or less, such that at least a part of the display panel is see-through.

According to a third aspect of the present disclosure, there is provided a non-transitory computer-readable recording medium storing a computer program causing a computer to execute a process including: determining whether or not a distance between a moving body able to move and be still and a display panel is a threshold or less; and controlling the display panel when the distance is determined to be the threshold or less, such that at least a part of the display panel is see-through.

### BRIEF DESCRIPTION OF THE DRAWINGS

FIG. 1A is a diagram illustrating an example operation of a display system according to Embodiment 1 of the present disclosure, and FIG. 1B is a diagram illustrating another example operation of the display system according to Embodiment 1;

FIG. 2 is a diagram illustrating yet another example operation of the display system according to Embodiment 1;

FIG. 3 is a function block diagram illustrating the display system according to Embodiment 1;

FIG. 4 is a diagram illustrating an imaging unit and a ranging unit of a detection unit according to Embodiment 1;

FIG. 5 is a flowchart illustrating a control method according to Embodiment 1;

FIG. 6 is a flowchart illustrating a detection signal process according to Embodiment 1;

FIG. 7 is a flowchart illustrating a transparency setting process according to Embodiment 1;

FIG. 8 is a flowchart illustrating a transparency process according to Embodiment 1;

FIG. 9 is a flowchart illustrating a panel driving process according to Embodiment 1;

FIG. 10 is a diagram illustrating an example operation of a display system according to Embodiment 2 of the present disclosure;

FIG. 11A is a diagram illustrating a first sight line angle according to Embodiment 2, and FIG. 11B is a diagram illustrating a second sight line angle according to Embodiment 2;

FIG. 12 is a flowchart illustrating a detection signal process according to Embodiment 2;

FIG. 13 is a flowchart illustrating a transparency setting process according to Embodiment 2;

FIG. 14A is a diagram illustrating a specific part according to Embodiment 3 of the present disclosure, and FIG. 14B is a diagram illustrating the specific part when the position of the specific part is changed according to Embodiment 3;

FIG. 15 is a flowchart illustrating a process when a display device according to Embodiment 3 receives input from a user; and

FIG. 16 is a flowchart illustrating a transparency setting process according to Embodiment 3.

### DESCRIPTION OF THE EMBODIMENTS

Hereinafter, embodiments of the present disclosure will be described with reference to the drawings. Note that in the drawings, portions which are identical or equivalent will be denoted with the same reference signs, and description thereof will not be repeated. Also, in the embodiments, the X axis and the Z axis are approximately parallel to the horizontal direction, the Y axis is approximately parallel to the vertical direction, and the X, Y, and Z axes are orthogonal to each other.

### Embodiment 1

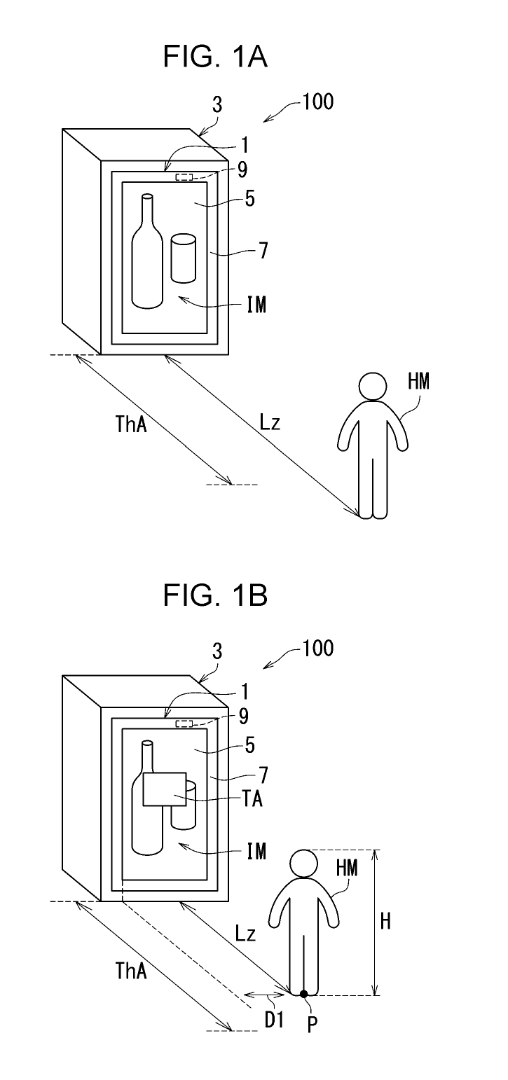

FIGS. 1A to 9 will be referenced to describe a display system 100 according to Embodiment 1 of the present disclosure. First, FIGS. 1A and 1B will be referenced to describe an example operation of the display system 100. FIGS. 1A and 1B are diagrams illustrating example operations of the display system 100. As illustrated in FIG. 1A, the display system 100 is provided with a display device 1 and a body 3. In Embodiment 1, the display device 1 and the body 3 constitute a housing device (for example, a refrigerated showcase). The body 3 is approximately box-shaped, and houses objects (for example, products). The display device 1 is openable and closable with respect to the body 3, and constitutes a door.

The display device 1 includes a display panel 5, a frame 7, and a controller 9. The display panel 5 displays an image IM. When not displaying the image IM, the display panel 5 is transparent and see-through. “Transparent” means colorless transparency, semi-transparency, or tinted transparency. In other words, “transparent” means that of the front side and back side of the display panel 5, an object positioned on the back side of the display panel 5 is visible from the front side. The display panel 5 is a liquid crystal display (LCD) panel or an organic electroluminescence (EL) panel, for example. The frame 7 supports the display panel 5.

The display panel 5 is formed by transparent electrodes, a transparent substrate, and a transparent material layer (such as a liquid crystal layer or an organic electroluminescence (EL) layer), for example. There are a variety of basic principles by which the display panel 5 may be configured to be see-through, but the present disclosure is applicable irrespectively of the type of basic principle. For example, the display panel 5 may be a transmissive LCD panel having a configuration in which a backlight is provided at a position (for example, a wall face inside the body 3) not facing opposite the back of the display face of the display panel 5. Alternatively, for example, the display panel 5 may be a self-luminous OLED panel. Hereinafter, an example of using a transmissive LCD panel as the display panel 5 will be described.

The controller 9 controls the display panel 5 such that the display panel 5 displays the image IM. The controller 9 is disposed inside the frame 7, for example. The controller 9 computes a distance Lz between a moving body HM and the display panel 5. the moving body HM is capable of moving and standing still. Typically, the moving body HM is a human being.

The controller 9 computes or acquires the distance Lz. Subsequently, the controller 9 determines whether or not the distance Lz is a first threshold ThA (threshold value) or less.

Additionally, as illustrated in FIG. 1B, when the distance Lz is the first threshold ThA or less, the controller 9 controls the display panel 5 such that at least a part TA of the display panel 5 is see-through. Consequently, in the display panel 5, among the region where the image IM is being displayed, a region included in “at least the part TA” is see-through. The “control such that at least the part TA of the display panel 5 is see-through” will be designated “transparency control”. On the other hand, when the distance Lz is greater than the first threshold ThA, the controller 9 does not execute the transparency control. Consequently, “at least the part TA of the display panel 5” is not set as a see-through region. Also, when the distance Lz changes from a value less than or equal to the first threshold ThA to a value greater than the first threshold ThA, the controller 9 ends the transparency control being executed. Consequently, “at least the part TA of the display panel 5” acting as a see-through region disappears. In the case of not executing the transparency control and in the case of ending the transparency control being executed, all of the image IM is displayed on the display panel 5.

As described above with reference to FIGS. 1A and 1B, according to Embodiment 1, when the distance Lz is the first threshold ThA or less, at least the part TA of the display panel 5 is see-through. Consequently, when looking at an object positioned on the back side of the display panel 5, it is possible to keep the image IM from getting in the way of visibility. As a result, in the case in which a human being acting as the moving body HM approaches the display panel 5 from the front side of the display panel 5, the human being easily is able to look through at least the part TA of the display panel 5 and see an object positioned on the back side of the display panel 5. For example, the human being easily is able to look through at least the part TA of the display panel 5 and see an object housed in the body 3.

Hereinafter, as illustrated in FIG. 1B, “at least the part TA of the display panel 5” is a specific part of the display panel 5 (hereinafter designated the “specific part TA”). Consequently, in the display panel 5, among the region where the image IM is being displayed, a region included in the specific part TA is see-through. Note that when the distance Lz is the first threshold ThA or less, the controller 9 may also control the display panel 5 such that all of the display panel 5 is see-through.

Specifically, the controller 9 computes the size of the specific part TA of the display panel 5 on the basis of the distance Lz. “Computing the size of the specific part TA” is one example of “deciding the size of the specific part TA”. More specifically, the controller 9 decreases the size of the specific part TA as the distance Lz becomes smaller. Note that the controller 9 may also increase the size of the specific part TA as the distance Lz becomes smaller.

Also, the controller 9 computes or acquires at least one from among a length H along the vertical direction of the moving body HM (specifically, a height H) and a position P of the moving body HM with respect to the display panel 5. Additionally, the controller 9 computes the position of the specific part TA of the display panel 5 on the basis of at least one of the length H and the position P of the moving body HM. “Computing the position of the specific part TA” is one example of “deciding the position of the specific part TA”. The position P of the moving body HM indicates a position in a first direction D1 of the moving body HM with respect to the display panel 5. The first direction D1 indicates a direction approximately parallel to the bottom edge or the top edge from among the four edges of the display panel 5. Note that the four edges of the display panel 5 refers to the top edge, the bottom edge, and the pair of side edges.

Subsequently, the controller 9 sets the size of the specific part TA to the computed size, and also sets the position of the specific part TA to the computed position. In other words, the controller 9 sets the specific part TA having the computed size at the computed position on the display panel 5.

As described above with reference to FIG. 1B, according to Embodiment 1, when the distance Lz is the first threshold ThA or less, the specific part TA of the display panel 5 is see-through. Consequently, it is possible to satisfy both the want of a human being close to the display panel 5 and the want of a human being far away from the display panel 5. The want of a human being who is close is to see an object positioned on the back side of the display panel 5 (for example, an object housed in the body 3). On the other hand, the want of a human being who is far away is to see the image IM displayed on the display panel 5.

Specifically, a human being who is close, that is, a human being acting as the moving body HM when the distance Lz is the first threshold ThA or less, is able to look through the specific part TA and see an object positioned on the back side of the display panel 5. On the other hand, a human being who is far away, that is, a human being when the distance between the human being and the display panel 5 is greater than the first threshold ThA, is able to see the image IM displayed on the display panel 5.

For example, an owner of the display system 100 is able to use the display device 1 as a promotional and advertising medium. In other words, a human being is able to look through the specific part TA and see a product positioned on the back side of the display panel 5. Consequently, the specific part TA functions as a promotional and advertising tool for the product with respect to a human being who is close to the display panel 5, for example. On the other hand, the display panel 5 is able to display the image IM for promotional and advertising purposes. Consequently, the display panel 5 functions as a promotional and advertising tool with respect to a human being who is far away from the display panel 5, for example.

Also, according to Embodiment 1, the size of the specific part TA is computed on the basis of the distance Lz. Consequently, the size of the specific part TA may be decreased as the distance Lz becomes smaller in the range less than or equal to the first threshold ThA, and the size of the specific part TA may be increased as the distance Lz becomes larger in the range less than or equal to the first threshold ThA. As a result, compared to the case in which the size of the specific part TA is fixed, the specific part TA may be set to an appropriate size corresponding to the distance Lz.

In particular, in the case of decreasing the size of the specific part TA as the distance Lz becomes smaller in the range less than or equal to the first threshold ThA, compared to the case in which the size of the specific part TA is fixed, the portion that becomes transparent and cut out of the image IM by the specific part TA becomes smaller. As a result, a human being far away from the display panel 5 is able to see the image IM more favorably.

Furthermore, according to Embodiment 1, the position of the specific part TA is computed on the basis of the length H, or in other words the height, of the human being acting as the moving body HM. Consequently, the position of the specific part TA may be set to a position corresponding to the height of the human being. As a result, the human being is able to look through the specific part TA and see an object positioned on the back side of the display panel 5 even more easily.

Furthermore, according to Embodiment 1, the position of the specific part TA is computed on the basis of the position P of the human being acting as the moving body HM. Consequently, the position of the specific part TA may be set to a position corresponding to the position P of the human being. As a result, the human being is able to look through the specific part TA and see an object positioned on the back side of the display panel 5 even more easily.

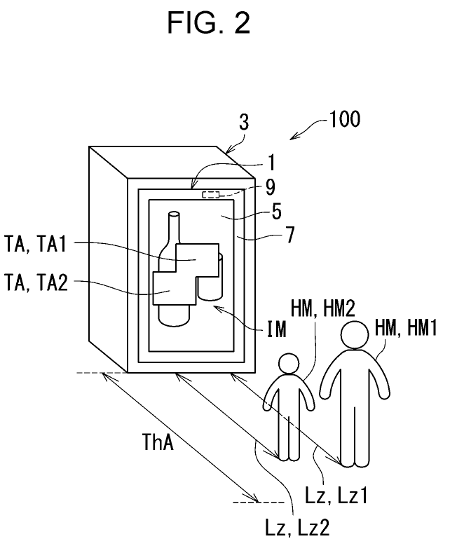

Next, FIG. 2 will be referenced to describe an example operation of the display system 100 in the case in which multiple moving bodies HM exist. FIG. 2 is a diagram illustrating an example operation of the display system 100. As illustrated in FIG. 2, the controller 9 computes or acquires the distance Lz between each of the multiple moving bodies HM and the display panel 5. Additionally, the controller 9 targets each of the multiple moving bodies HM and determines whether or not the distance Lz is the first threshold ThA. Furthermore, in the case in which the distance Lz is determined to be the first threshold ThA or less with respect to each of two or more moving bodies HM among the multiple moving bodies HM, the controller 9 sets the specific part TA in correspondence with each of the two or more moving bodies HM on the display panel 5. In other words, two or more specific parts TA are set on the display panel 5. Additionally, the controller 9 controls the display panel 5 such that each specific part TA of the display panel 5 is see-through.

For example, the controller 9 computes or acquires a distance Lz1 between a moving body HM1 and the display panel 5, and a distance Lz2 between a moving body HM2 and the display panel 5. Additionally, in the case in which the distance Lz1 is determined to be the first threshold ThA or less, the controller 9 sets a specific part TA1 in correspondence with the moving body HM1 on the display panel 5. Also, in the case in which the distance Lz2 is determined to be the first threshold ThA or less, the controller 9 sets a specific part TA2 in correspondence with the moving body HM2 on the display panel 5. Additionally, the controller 9 controls the display panel 5 such that each of the specific part TA1 and the specific part TA2 of the display panel 5 is see-through.

As described above with reference to FIG. 2, according to Embodiment 1, the specific part TA is set on the display panel 5 in correspondence with each of two or more human beings acting as moving bodies HM. Consequently, compared to the case in which a single specific part TA is set with respect to two or more human beings, each of the two or more human beings is able to look through the specific part TA corresponding to oneself and see an object positioned on the back side of the display panel 5 more easily.

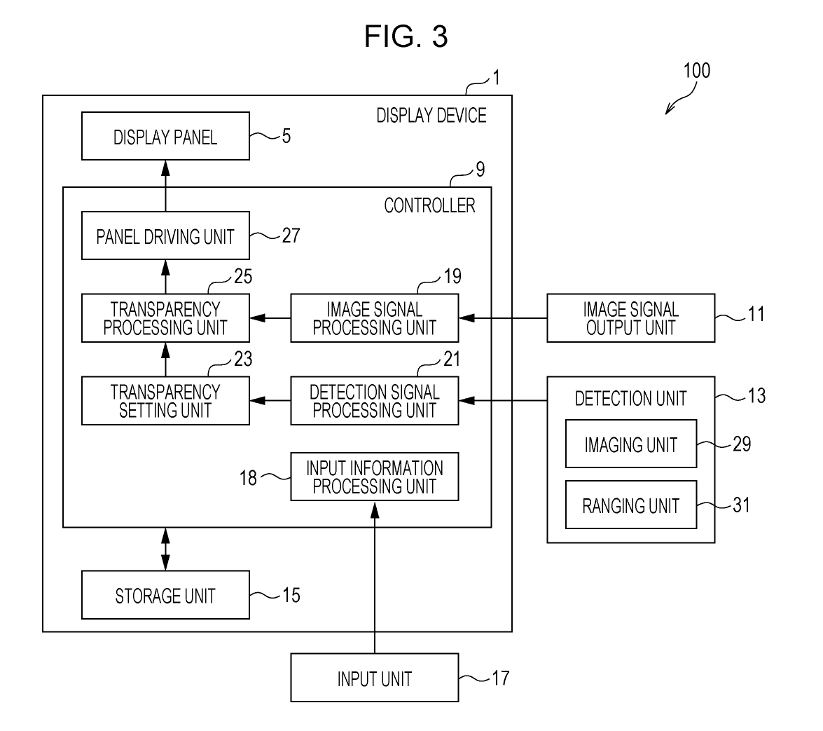

Next, FIG. 3 will be referenced to describe the display system 100. FIG. 3 is a function block diagram illustrating the display system 100. As illustrated in FIG. 3, the display system 100 preferably is provided with an image signal output unit 11, a detection unit 13, and an input unit 17 in addition to the display device 1. The image signal output unit 11 outputs an analog or digital image signal to the controller 9 of the display device 1. The image signal may include a moving image or a still image. The image signal output unit 11 includes a personal computer or a television receiver, for example.

The detection unit 13 detects the moving body HM and outputs a detection signal of the moving body HM to the controller 9 of the display device 1. For example, the detection unit 13 includes an imaging unit 29 and a ranging unit 31. The imaging unit 29 images the moving body HM and outputs an imaging signal to the controller 9 as a detection signal. The imaging unit 29 includes a camera, for example. The ranging unit 31 detects the distance of the moving body HM with respect to the display panel 5, and outputs a ranging signal to the controller 9 as a detection signal. The ranging unit 31 includes a range sensor, for example. The first threshold ThA is set to a value within a range by which the detection unit 13 is able to detect the moving body HM.

The input unit 17 receives the input of information from a user, and outputs an input signal including the received information to the controller 9. The input unit 17 includes various operation buttons, for example.

The controller 9 computes the distance Lz between the moving body HM and the display panel 5 as well as the position P of the moving body HM on the basis of a detection result of the detection unit 13 (specifically, the detection result of the ranging unit 31). Consequently, according to Embodiment 1, the distance Lz and the position P may be computed accurately.

Also, the controller 9 computes the length H of the moving body HM on the basis of the detection result of the detection unit 13 (specifically, the imaging result of the imaging unit 29). Consequently, according to Embodiment 1, the length H of the moving body HM may be computed accurately.

The display device 1 preferably additionally includes a storage unit 15 in addition to the display panel 5 and the controller 9. The storage unit 15 stores data and computer programs. For example, the storage unit 15 temporarily stores data relevant to each process of the controller 9, and stores settings data for the display device 1. The storage unit 15 includes storage devices (a main storage device and an auxiliary storage device), such as memory and a hard disk drive, for example. The storage unit 15 may also include removable media.

The controller 9 includes an image signal processing unit 19, a detection signal processing unit 21, a transparency setting unit 23, a transparency processing unit 25, and a panel driving unit 27. The controller 9 preferably additionally includes an input information processing unit 18.

The input information processing unit 18 receives an input signal output by the input unit 17. Additionally, the input information processing unit 18 processes the input signal, and changes the state of the display device 1 according to an input processing algorithm. Changing the state of the display device 1 includes causing the storage unit 15 to store data, for example.

The image signal processing unit 19 receives an image signal output by the image signal output unit 11. Additionally, the image signal processing unit 19 executes image processing (for example, spatiotemporal filter processing) on the image signal, and outputs the processed image signal to the transparency processing unit 25.

The detection signal processing unit 21 receives a detection signal from the detection unit 13 on a fixed time interval. Additionally, on the basis of the detection signal, the detection signal processing unit 21 computes the distance Lz as well as the length H and position P of the moving body HM. Subsequently, the detection signal processing unit 21 outputs data indicating the distance Lz, the length H, and the position P to the transparency setting unit 23.

The transparency setting unit 23 sets the specific part TA on the display panel 5. Specifically, the transparency setting unit 23 computes the position and size of the specific part TA on the basis of the distance Lz, the length H, and the position P. Additionally, the transparency setting unit 23 outputs data indicating the position and size of the specific part TA to the transparency processing unit 25.

On the basis of the position and size of the specific part TA, the transparency processing unit 25 specifies the region corresponding to the specific part TA (hereinafter designated the “transparency target region”) in the image indicated by the image signal from the image signal processing unit 19. Subsequently, the transparency processing unit 25 sets the transparency target region to a transparent color. A “transparent color” means colorless transparency, semi-transparency, or tinted transparency. Furthermore, the transparency processing unit 25 outputs, to the panel driving unit 27, image data indicating an image after setting the transparency target region to a transparent color.

The panel driving unit 27 drives the display panel 5 such that the display panel 5 displays the image indicated by the image data. As a result, the display panel 5 displays an image while also causing the specific part TA to be see-through.

Note that the controller 9 includes an image processing circuit, a display driver, and a processor, for example. Additionally, for example, the image signal processing unit 19 is realized by the image processing circuit, while the panel driving unit 27 is realized by the display driver. Also, by executing computer programs stored in the storage unit 15, the processor functions as the detection signal processing unit 21, the transparency setting unit 23, and the transparency processing unit 25. Also, the controller 9 constitutes a computer.

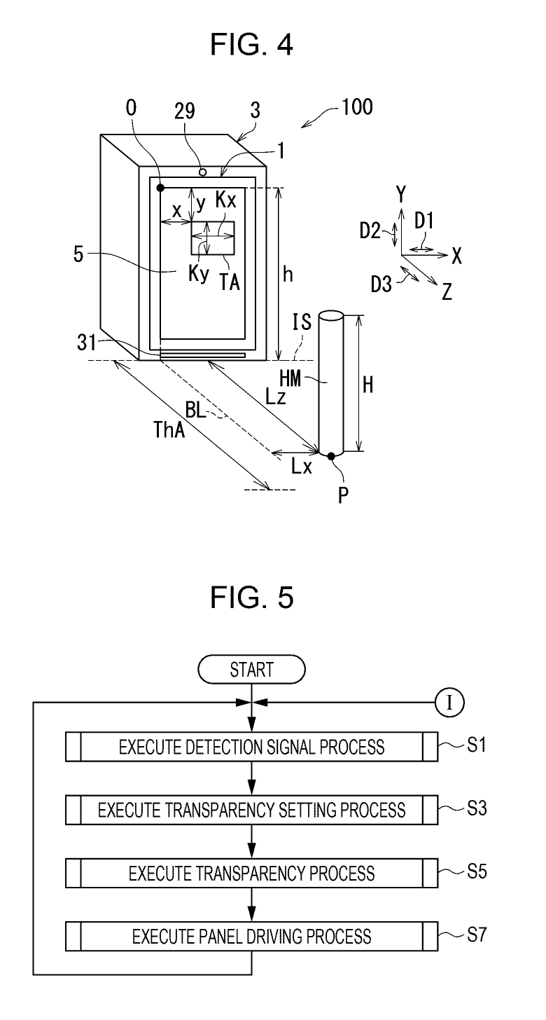

Next, FIGS. 3 and 4 will be referenced to describe the detection unit 13, the detection signal processing unit 21, and the transparency setting unit 23. FIG. 4 is a diagram illustrating the imaging unit 29 and the ranging unit 31 of the detection unit 13.

As illustrated in FIG. 4, the installation location of the imaging unit 29 is not particularly limited insofar as the location allows the imaging unit 29 to capture an overall image of the moving body HM. Accordingly, for example, the imaging unit 29 is installed on a top front edge of the body 3. The imaging unit 29 images the moving body HM, and outputs an imaging signal including a captured image of the moving body HM to the detection signal processing unit 21. The detection signal processing unit 21 computes the length H of the moving body HM on the basis of the imaging signal. For example, the detection signal processing unit 21 computes the length H of the moving body HM on the basis of the position of an apex (specifically, the top of the head) of the moving body HM included in the captured image and the distance Lz between the moving body HM and the display panel 5.

The installation location of the ranging unit 31 is not particularly limited insofar as the location allows the ranging unit 31 to detect the distance Lz between the display device 1 and the moving body HM. Accordingly, for example, the ranging unit 31 is installed on a bottom front edge of the body 3, extending along the first direction D1. For example, the ranging unit 31 detects the distance Lz between the moving body HM and the display panel 5 by irradiating the moving body HM with light waves or sound waves, and receiving the light waves or sound waves reflected by the moving body HM. Consequently, the distance Lz is expressed by the distance between the moving body HM and the ranging unit 31. The ranging unit 31 outputs a first ranging signal corresponding to the distance Lz to the detection signal processing unit 21. The detection signal processing unit 21 computes the distance Lz on the basis of the first ranging signal.

For example, the ranging unit 31 and the detection signal processing unit 21 are configured in accordance with the triangulation method, and execute processes in accordance with the triangulation method. Additionally, for example, the triangulation method utilizing light waves is a method of converting changes in the image formation position of the moving body HM on a light sensor caused by distance changes of the moving body HM into the distance Lz. Consequently, the ranging unit 31 includes a light emitter and a light sensor, and outputs a light detection signal of the light sensor as the first ranging signal. Subsequently, the detection signal processing unit 21 computes the distance Lz on the basis of the first ranging signal according to the triangulation method.

Also, for example, the ranging unit 31 detects the position P of the moving body HM by irradiating the moving body HM with light and receiving the light reflected by the moving body HM. The position P is defined by a horizontal distance Lx. The horizontal distance Lx indicates a distance along the first direction D1 of the moving body HM with respect to a baseline BL. The baseline BL is approximately parallel to a third direction D3. The third direction D3 indicates a direction approximately orthogonal to the display face of the display panel 5. Additionally, the baseline BL is approximately orthogonal to a side edge of the display panel 5. The ranging unit 31 outputs a second ranging signal corresponding to the horizontal distance Lx to the detection signal processing unit 21. The detection signal processing unit 21 computes the horizontal distance Lx on the basis of the second ranging signal.

For example, the ranging unit 31 includes K optical sensors. Herein, “K” is an integer equal to or greater than 2. Each optical sensor includes a light emitter and a light sensor. The K optical sensors are disposed in a straight line along the first direction D1. Each optical sensor has a width W along the first direction D1. The ranging unit 31 outputs a light detection signal of the light sensor in each optical sensor as the second ranging signal. Subsequently, if from among the 1st to Kth optical sensors, the kth optical sensor from the side of the baseline BL detects the moving body HM, the detection signal processing unit 21 computes “k×W” as the horizontal distance Lx.

The transparency setting unit 23 uses the horizontal distance Lx, a height h of the display panel 5, and the length H of the moving body HM to compute coordinates (x, y) according to Formulas (1) and (2). The coordinates (x, y) indicate the position of the specific part TA. For example, the coordinates (x, y) indicate the position of one corner of the specific part TA. The coordinates (x, y) indicate coordinates in a two-dimensional orthogonal coordinate system set in the display panel 5. A coordinate origin O is set at the point of intersection between one side edge and the top edge of the display panel 5. The coordinate “x” indicates the position in the first direction D1 on the display panel 5. The coordinate “y” indicates the position in a second direction D2 on the display panel 5. The second direction D2 indicates a direction approximately parallel to the side edges from among the four edges of the display panel 5. The height h indicates the height of the display panel 5 with respect to an installation surface IS. Note that the display panel 5 may be installed directly on the installation surface IS, or installed indirectly on the installation surface IS.

x=Lx (1)

y=h−H (2)

The transparency setting unit 23 uses the distance Lz, the first threshold ThA, a first constant C1, and a second constant C2 to compute a horizontal width Kx of the specific part TA according to Formula (3), and computes a vertical width of specific part TA according to Formula (4). The horizontal width Kx and the vertical width Ky indicate the size of the specific part TA. The horizontal width Kx indicates the length of the specific part TA along the first direction D1. The vertical width Ky indicates the length of the specific part TA along the second direction D2. The first constant C1 corresponds to the horizontal width Kx, and indicates a fixed value prescribing the aspect ratio (Kx/Ky) of the specific part TA. The second constant C2 corresponds to the vertical width Ky, and indicates a fixed value prescribing the aspect ratio of the specific part TA. For example, the first constant C1 is greater than the second constant C2.

Kx=C1+(Lz/ThA)×(C1/C2) (3)

Ky=C2+(Lz/ThA) (4)

In Formula (3), the second term “(Lz/ThA)×(C1/C2)” indicates the value of a variable corresponding to the distance Lz. Also, in Formula (4), the second term “(Lz/ThA)” indicates the value of a variable corresponding to the distance Lz. Furthermore, in Formula (3), since “(Lz/ThA)” is multiplied by “(C1/C2)”, even if the distance Lz changes, the aspect ratio of the specific part TA becomes approximately the same ratio (C1/C2).

Next, FIGS. 3 and 5 will be referenced to describe a control method executed by the controller 9 of the display device 1. FIG. 5 is a flowchart illustrating the control method. As illustrated in FIG. 5, the control method includes steps S1 to S7. For example, a computer program stored in the storage unit 15 causes the controller 9 to execute the control method.

As illustrated in FIGS. 3 and 5, in step S1, the detection signal processing unit 21 executes a detection signal process. In step S3, the transparency setting unit 23 executes a transparency setting process. In step S5, the transparency processing unit 25 executes a transparency process. Step S5 corresponds to, for example, a “step of controlling the display panel 5 such that at least the part TA of the display panel 5 is see-through when the distance Lz is determined to be the first threshold ThA or less”. In step S7, the panel driving unit 27 executes a panel driving process. After step S7, the process proceeds to step S1.

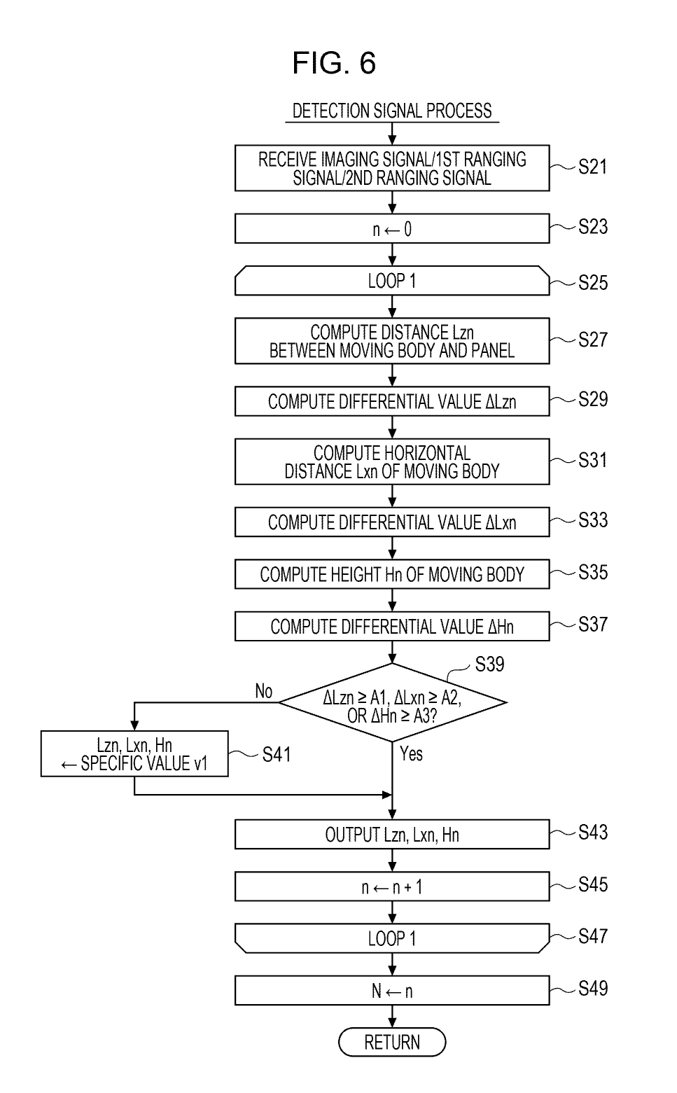

Next, FIGS. 3 and 6 will be referenced to describe step S1 of FIG. 5. FIG. 6 is a flowchart illustrating the detection signal process in step S1 of FIG. 5. As illustrated in FIG. 6, the detection signal process includes steps S21 to S49.

As illustrated in FIGS. 3 and 6, in step S21, the detection signal processing unit 21 receives the imaging signal from the imaging unit 29, and receives the first and second ranging signals from the ranging unit 31.

In step S23, the detection signal processing unit 21 sets a variable n to zero. Subsequently, the detection signal processing unit 21 repeats the process from step S25 to step S47 until the computation of a distance Lzn, a horizontal distance Lxn, and a length Hn based on the imaging signal, the first ranging signal, and the second ranging signal becomes unavailable. In step S27, the detection signal processing unit 21 computes the distance Lzn between the moving body HM and the display panel 5 on the basis of the first ranging signal.

In step S29, the detection signal processing unit 21 computes a differential value ΔLzn. The differential value ΔLzn indicates the absolute value of the difference between the previously computed distance Lzn and the currently computed distance Lzn.

In step S31, the detection signal processing unit 21 computes the horizontal distance Lxn of the moving body HM on the basis of the second ranging signal.

In step S33, the detection signal processing unit 21 computes a differential value ΔLxn. The differential value ΔLxn indicates the absolute value of the difference between the previously computed horizontal distance Lxn and the currently computed horizontal distance Lxn.

In step S35, the detection signal processing unit 21 computes the length Hn of the moving body HMn on the basis of the imaging signal.

In step S37, the detection signal processing unit 21 computes a differential value ΔHn. The differential value ΔHn indicates the absolute value of the difference between the previously computed length Hn and the currently computed length Hn.

In step S39, the detection signal processing unit 21 determines whether or not the differential value ΔLzn is a first predetermined value A1 or greater, whether or not the differential value ΔLxn is a second predetermined value A2 or greater, and whether or not the differential value ΔHn is a third predetermined value A3 or greater. The first predetermined value A1 indicates a threshold value for determining the magnitude of the differential value ΔLzn, or in other words, whether or not the amount of change in the distance Lzn is large. The second predetermined value A2 indicates a threshold value for determining the magnitude of the differential value ΔLxn, or in other words, whether or not the amount of change in the horizontal distance Lxn is large. The third predetermined value A3 indicates a threshold value for determining the magnitude of the differential value ΔHn, or in other words, whether or not the amount of change in the length Hn is large.

When the detection signal processing unit 21 makes a negative determination (step S39, No), the process proceeds to step S41. A negative determination indicates that the differential value ΔLzn is determined to be less than the first predetermined value A1, the differential value ΔLxn is determined to be less than the second predetermined value A2, and the differential value ΔHn is determined to be less than the third predetermined value A3.

In step S41, the detection signal processing unit 21 sets each of the distance Lzn, the horizontal distance Lxn, and the length Hn to a specific value v1. The specific value v1 is zero, for example.

On the other hand, when the detection signal processing unit 21 makes a positive determination (step S39, Yes), the process proceeds to step S43. A positive determination indicates that the differential value ΔLzn is determined to be equal to or greater than the first predetermined value A1, the differential value ΔLxn is determined to be equal to or greater than the second predetermined value A2, or the differential value ΔHn is determined to be equal to or greater than the third predetermined value A3.

In step S43, the detection signal processing unit 21 outputs data indicating the distance Lzn, the horizontal distance Lxn, and the length Hn to the transparency setting unit 23.

In step S45, the detection signal processing unit 21 increments the variable n by 1. In step S49, the detection signal processing unit 21 substitutes the value of the variable n into the number N of moving bodies HMn.

As described above with reference to FIG. 6, according to Embodiment 1, the distance Lzn, the horizontal distance Lxn, and the length Hn are computed on the basis of a detection result from the detection unit 13. “Computing the distance Lzn, the horizontal distance Lxn, and the length Hn” is one example of “deciding the distance Lzn, the horizontal distance Lxn, and the length Hn”.

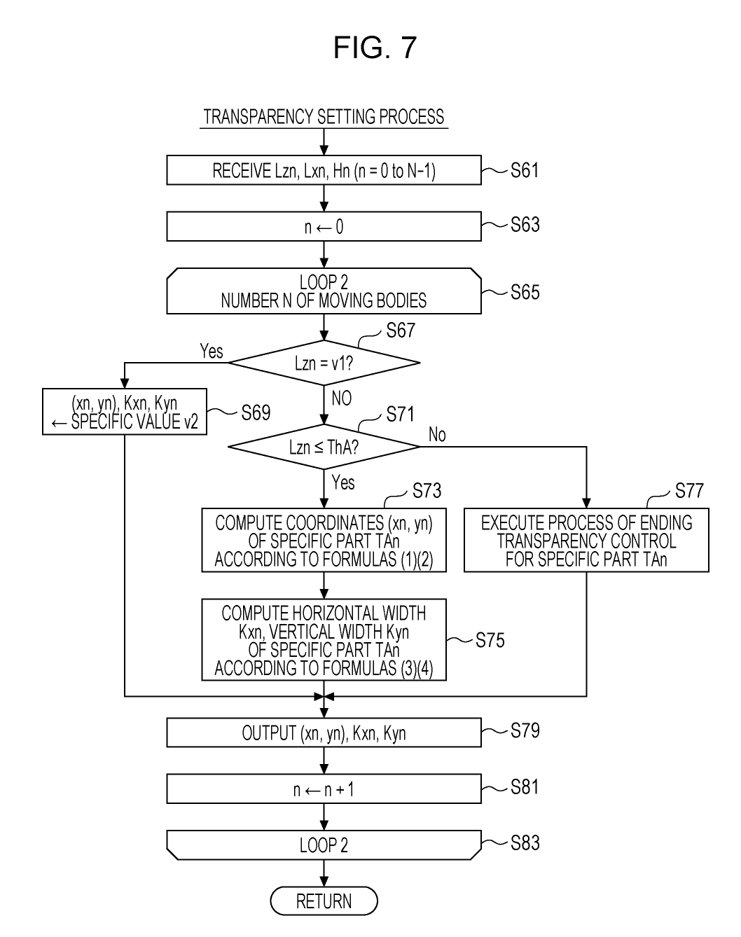

Next, FIGS. 3 and 7 will be referenced to describe step S3 of FIG. 5. FIG. 7 is a flowchart illustrating the transparency setting process in step S3 of FIG. 5. As illustrated in FIG. 7, the transparency setting process includes steps S61 to S83.

As illustrated in FIGS. 3 and 7, in step S61, the transparency setting unit 23 receives data indicating the distance Lzn, the horizontal distance Lxn, and the length Hn in correspondence with n=0 to (N−1) from the detection signal processing unit 21.

In step S63, the transparency setting unit 23 sets the variable n to zero. Additionally, the transparency setting unit 23 starts from n=0, repeats the process from step S65 to step S83 a number of times equal to the number N of moving bodies HMn, and exits the loop when the value of the variable n becomes “N”.

In step S67, the transparency setting unit 23 determines whether or not the distance Lzn is set to the specific value v1. When the transparency setting unit 23 makes a positive determination (step S67, Yes), the process proceeds to step S69. In step S69, the transparency setting unit 23 sets each of the coordinates (xn, yn), the horizontal width Kxn, and the vertical width Kyn of the specific part TAn to a specific value v2. The specific value v2 is zero, for example. Subsequently, the process proceeds to step S79.

On the other hand, when the transparency setting unit 23 makes a negative determination (step S67, No), the process proceeds to step S71. In step S71, the transparency setting unit 23 determines whether or not the distance Lzn is the first threshold ThA or less.

When the transparency setting unit 23 makes a negative determination (step S71, No), the process proceeds to step S77.

In step S77, the transparency setting unit 23 executes a process of ending transparency control for the specific part TAn. The process of ending transparency control refers to a process of ending the control by which the specific part TAn becomes see-through. For example, the transparency setting unit 23 sets the size of the specific part TAn to zero (Kxn=Kyn=0) at the coordinates (xn, yn)=(0, 0) of the specific part TAn. By the process of ending transparency control, the “specific part TAn” acting as a see-through region is not set, or disappears.

On the other hand, when the transparency setting unit 23 makes a positive determination (step S71, Yes), the process proceeds to step S73.

In step S73, the transparency setting unit 23 computes the coordinates (xn, yn) of the specific part TAn according to Formulas (1) and (2).

In step S75, the transparency setting unit 23 computes the horizontal width Kxn and the vertical width Kyn of the specific part TAn according to Formulas (3) and (4).

In step S79, the transparency setting unit 23 outputs data indicating the coordinates (xn, yn), the horizontal width Kxn, and the vertical width Kyn of the specific part TAn to the transparency processing unit 25. In step S81, the transparency setting unit 23 increments the variable n by 1.

As described above with reference to FIGS. 6 and 7, according to Embodiment 1, when the amount of change in each of the distance Lzn, the distance Lxn, and the height Hn is small (No in step S39, Yes in step S67), step S73 and step S75 are skipped, and the coordinates (xn, yn), the horizontal width Kxn, and the vertical width Kyn are not computed. As a result, the processing load on the transparency setting unit 23 may be reduced.

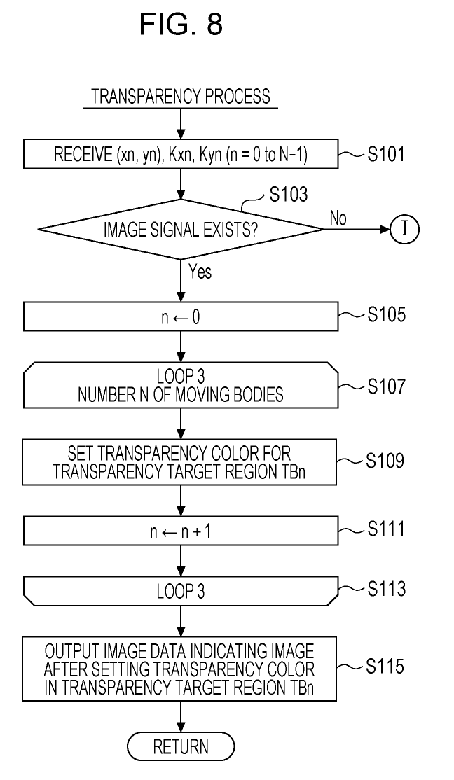

Next, FIGS. 3 and 8 will be referenced to describe step S5 of FIG. 5. FIG. 8 is a flowchart illustrating the transparency process in step S5 of FIG. 5. As illustrated in FIG. 8, the transparency process includes steps S101 to S115.

As illustrated in FIGS. 3 and 8, in step S101, the transparency processing unit 25 receives data indicating the coordinates (xn, yn), the horizontal width Kxn, and the vertical width Kyn of the specific part TAn in correspondence with n=0 to (N−1) from the transparency setting unit 23.

In step S103, the transparency processing unit 25 determines whether or not an image signal from the image signal output unit 11 exists.

When the transparency processing unit 25 makes a negative determination (step S103, No), the process proceeds to step S1 of FIG. 5.

On the other hand, when the transparency processing unit 25 makes a positive determination (step S103, Yes), the process proceeds to step S105. In step S105, the transparency processing unit 25 sets the variable n to zero. Additionally, the transparency processing unit 25 starts from n=0, and repeats the process from step S107 to step S113 a number of times equal to the number N of moving bodies HMn. Subsequently, the transparency processing unit 25 exits the loop when the value of the variable n becomes “N”, and the process proceeds to step S115.

In step S109, the transparency processing unit 25 prescribes the specific part TAn according to the coordinates (xn, yn), the horizontal width Kxn, and the vertical width Kyn of the specific part TAn, and in the image indicated by the image signal from the image signal processing unit 19, sets a region TBn corresponding to the specific part TAn, that is, a transparency target region TBn, to a transparent color. In other words, the transparency processing unit 25 processes the transparency target region TBn such that the transparency target region TBn becomes transparent. For example, in the case in which the display panel 5 is a device that transmissively displays black regions of the display panel 5, the transparency processing unit 25 fills the transparency target region TBn with a black color as the transparency process. Filling with a black color corresponds to setting the transparency target region TBn to a transparent color. Note that the “image indicated by the image signal” refers to an overall image including the image IM and a background image of the image IM. The “image indicated by the image signal” has a rectangular shape.

Note that in the case in which the coordinates (xn, yn) are set to the specific value v2, the transparency processing unit 25 sets the previous transparency target region TBn to the transparent color.

In step S111, the transparency processing unit 25 increments the variable n by 1. In step S115, the transparency processing unit 25 outputs image data indicating the image processed in step S109 to the panel driving unit 27.

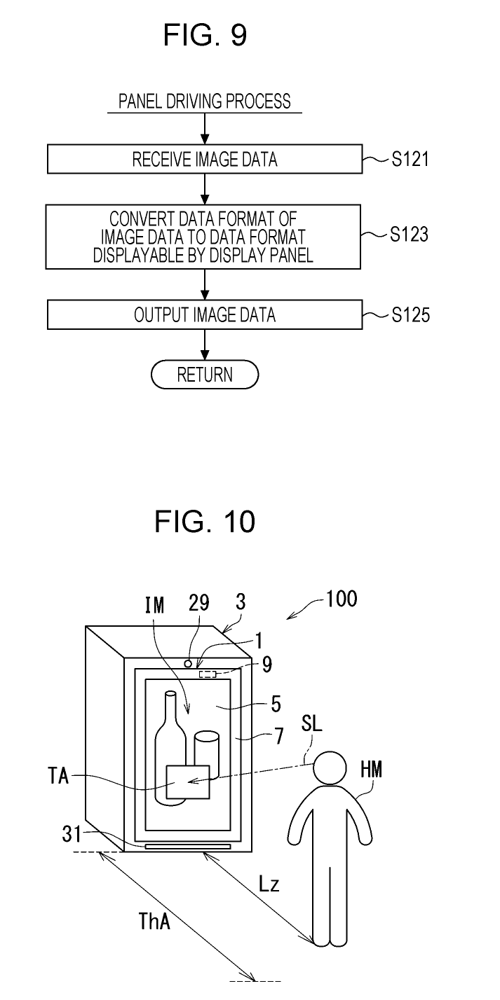

Next, FIGS. 3 and 9 will be referenced to describe step S7 of FIG. 5. FIG. 9 is a flowchart illustrating the panel driving process in step S7 of FIG. 5. As illustrated in FIG. 9, the panel driving process includes steps S121 to S125.

As illustrated in FIGS. 3 and 9, in step S121, the panel driving unit 27 receives image data indicating the image processed in step S109 (FIG. 8) from the transparency processing unit 25.

In step S123, the panel driving unit 27 converts the data format of the image data to a data format displayable by the display panel 5.

In step S125, the panel driving unit 27 outputs the image in the converted data format to the display panel 5. As a result, the display panel 5 displays an image based on the image data such that the specific part TAn corresponding to the transparency target region TBn is see-through.

### Embodiment 2

FIG. 3 and FIGS. 10 to 13 will be referenced to describe a display system 100 according to Embodiment 2 of the present disclosure. Embodiment 2 principally differs from Embodiment 1 in that the display system 100 according to Embodiment 2 decides the position of the specific part TA according to a sight line of a human being acting as the moving body HM. Hereinafter, the points in Embodiment 2 that are different from Embodiment 1 will be described mostly. Also, since the configuration of the display system 100 according to Embodiment 2 is similar to the configuration of the display system 100 according to Embodiment 1, FIG. 3 will be referenced where appropriate.

First, FIG. 10 will be referenced to describe an example operation of the display system 100 according to Embodiment 2. FIG. 10 is a diagram illustrating an example operation of the display system 100. As illustrated in FIG. 10, when the distance Lz between the moving body HM and the display panel 5 is the first threshold ThA or less, the controller 9 controls the display panel 5 such that the specific part TA of the display panel 5 is see-through.

Specifically, the controller 9 computes a sight line SL (specifically, a sight direction) of the moving body HM on the basis of an imaging result from the imaging unit 29. For example, the controller 9 computes the sight line SL of the moving body HM by executing eye tracking technology (for example, a corneal reflection method, a dark pupil method, or a bright pupil method). Subsequently, the controller 9 computes the position of the specific part TA of the display panel 5 on the basis of at least the sight line SL. “Computing the position of the specific part TA” is one example of “deciding the position of the specific part TA”. The controller 9 sets the position of the specific part TA to the computed position. In other words, the controller 9 sets the specific part TA at the computed position on the display panel 5. Additionally, the controller 9 controls the display panel 5 such that the specific part TA of the display panel 5 is see-through.

As described above with reference to FIG. 10, according to Embodiment 2, similarly to Embodiment 1, a human being acting as the moving body HM is able to look through the specific part TA and easily see an object positioned on the back side of the display panel 5. Otherwise, Embodiment 2 exhibits effects similar to Embodiment 1.

In addition, according to Embodiment 2, the position of the specific part TA is computed on the basis of the sight line SL of the human being acting as the moving body HM. Consequently, the position of the specific part TA may be set to a position corresponding to the sight line SL of the human being. As a result, the human being is able to look through the specific part TA and see an object positioned on the back side of the display panel 5 even more easily.

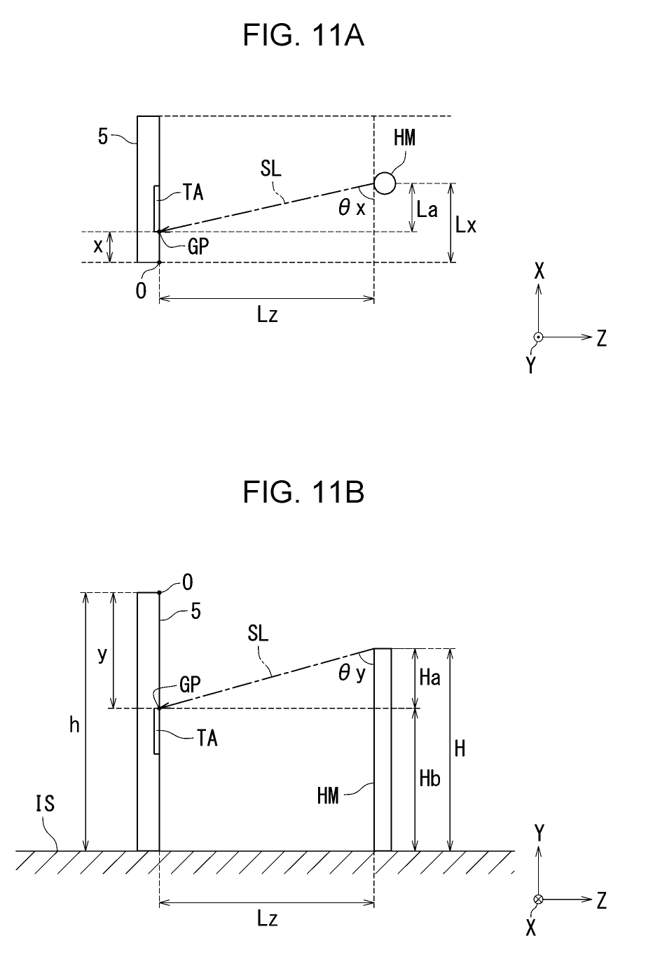

Next, FIG. 3 and FIGS. 11A and 11B will be referenced to describe a procedure for computing the position of the specific part TA based on the sight line SL. FIGS. 11A and 11B are diagrams illustrating the sight line SL of the moving body HM. In FIG. 11A, the display panel 5 and the moving body HM are seen from above the display panel 5 and the moving body HM. In FIG. 11B, the display panel 5 and the moving body HM are seen from the side of the display panel 5 and the moving body HM.

As illustrated in FIGS. 11A and 11B, the sight line SL is defined by a first sight line angle θx and a second sight line angle θy. The first sight line angle θx indicates an angle in the horizontal direction of the sight line SL. The second sight line angle θy indicates an angle in the vertical direction of the sight line SL.

Additionally, as illustrated in FIGS. 3, 11A, and 11B, the transparency setting unit 23 uses the horizontal distance Lx, the distance Lz, the first sight line angle θx, the height h of the display panel 5, the length H of the moving body HM, and the second sight line angle θy to compute the coordinates (x, y) of the specific part TA according to Formulas (5) and (6). The distance La in Formula (5) indicates the length of an adjacent side of the right triangle having the first sight line angle θx as an interior angle. The length of the opposite side of the right triangle matches the distance Lz. The distance Ha in Formula (6) indicates the length of an adjacent side of the right triangle having the second sight line angle θy as an interior angle. The length of the opposite side of the right triangle matches the distance Lz. The distance Hb in Formula (6) indicates the height of a gaze point GP with respect to the installation surface IS of the display panel 5. The gaze point GP indicates the intersection point between the sight line SL and the display panel 5.

x=Lx−La=Lx−(Lz/tan θx) (5)

y=h−Hb=h−(H−Ha)=h−(H−(Lz/tan θy)) (6)

Herein, the coordinates (x, y) of the specific part TA are the same as the coordinates (xg, yg) of the gaze point GP. Consequently, the coordinates (xg, yg) of the gaze point GP may be computed by Formulas (5) and (6). Additionally, it is furthermore preferable to compute the coordinates (x, y) of the specific part TA such that the coordinates (xg, yg) of the gaze point GP indicate a center position of the specific part TA.

Note that, as illustrated in FIG. 3, the detection signal processing unit 21 computes the first sight line angle θx and the second sight line angle θy on the basis of the imaging signal from the imaging unit 29.

For example, the captured image indicated by the imaging signal includes an image of an eye of the human being acting as the moving body HM. Additionally, the detection signal processing unit 21 computes a motion vector of a moving point with respect to a reference point set in the eye in the captured image. The reference point is set to a center point of the iris when the eye is facing forward, for example. The moving point is a center point of the iris when the iris moves, for example. Additionally, the detection signal processing unit 21 decomposes the motion vector into a horizontal component and a vertical component. Furthermore, the detection signal processing unit 21 computes the first sight line angle θx on the basis of the horizontal component and a length Lh (not illustrated), and computes the second sight line angle θy on the basis of the vertical component and a length Lv (not illustrated). For example, the detection signal processing unit 21 sets the first sight line angle θx when the iris is positioned at the left edge of the eye to 0 degrees, sets the first sight line angle θx when the iris is positioned at the reference point to 90 degrees, and sets the first sight line angle θx when the iris is positioned at the right edge of the eye to 180 degrees. Also, the detection signal processing unit 21 sets the length Lh of the horizontal component when the iris is positioned at the right edge of the eye to “Lm”. Consequently, the first sight line angle θx when the iris is positioned between the reference point and the right edge of the eye becomes “90+(Lh/Lm)×90”.

Next, FIGS. 3, 5, 8, and 9 will be referenced to describe a control method executed by the controller 9 of the display device 1. As illustrated in FIG. 5, the control method according to Embodiment 2 includes steps S1 to S7, similarly to Embodiment 1. In step S1, the detection signal processing unit 21 computes the distance Lz as well as the length H, the position P, and the sight line SL of the moving body HM on the basis of the detection signal received from the detection unit 13. In step S3, the transparency setting unit 23 computes the position and size of the specific part TA on the basis of the distance Lz, the length H, the position P, and the sight line SL. Step S5 and step S7 according to Embodiment 2 are similar to the transparency process illustrated in FIG. 8 and the panel driving process illustrated in FIG. 9, respectively.

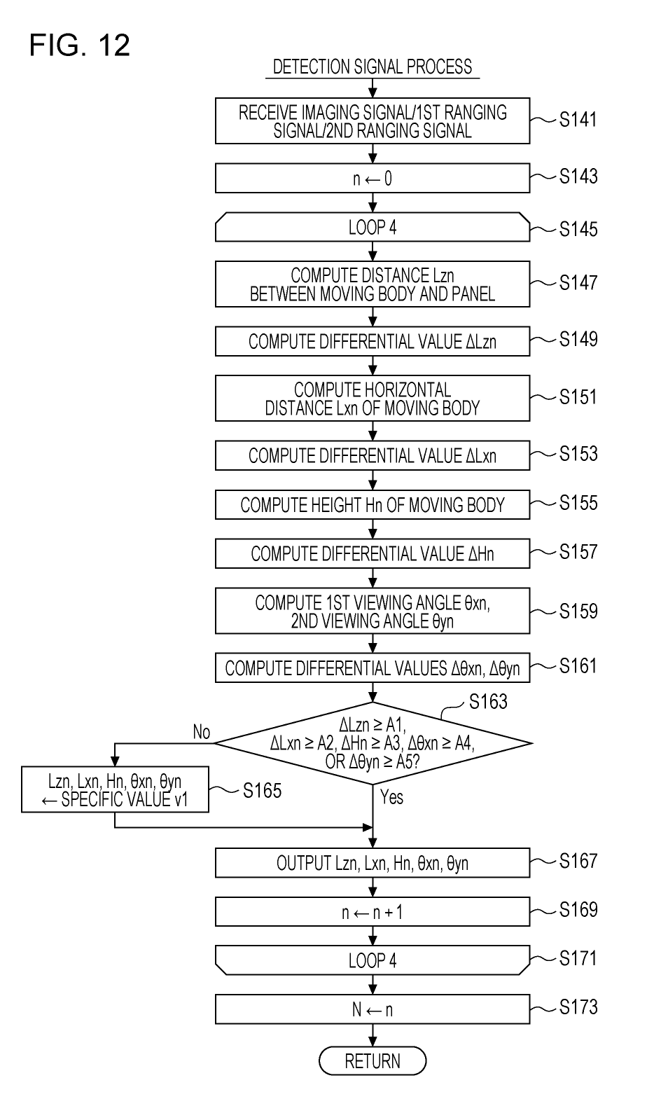

Next, FIGS. 3 and 12 will be referenced to describe step S1 of FIG. 5. FIG. 12 is a flowchart illustrating the detection signal process in step S1 of FIG. 5. As illustrated in FIG. 12, the detection signal process includes steps S141 to S173.

As illustrated in FIGS. 3 and 12, in step S141, the detection signal processing unit 21 receives the imaging signal from the imaging unit 29, and receives the first and second ranging signals from the ranging unit 31.

In step S143, the detection signal processing unit 21 sets the variable n to zero. Subsequently, the detection signal processing unit 21 repeats the process from step S145 to step S171 until the computation of the distance Lzn, the horizontal distance Lxn, the length Hn, the first sight line angle θxn, and the second sight line angle θyn based on the imaging signal, the first ranging signal, and the second ranging signal becomes unavailable.

Steps S147 to S157 are similar to steps S27 to S37 illustrated in FIG. 6, respectively.

In step S159, the detection signal processing unit 21 computes the first sight line angle θxn and the second sight line angle θyn of the moving body HMn on the basis of the imaging signal.

In step S161, the detection signal processing unit 21 computes a differential value Δθxn and a differential value Δθyn. The differential value Δθxn indicates the absolute value of the difference between the previously computed first sight line angle θxn and the currently computed first sight line angle θxn. The differential value Δθyn indicates the absolute value of the difference between the previously computed first sight line angle θyn and the currently computed first sight line angle θyn.

In step S163, the detection signal processing unit 21 determines whether or not the differential value ΔLzn is the first predetermined value A1 or greater, whether or not the differential value ΔLxn is the second predetermined value A2 or greater, whether or not the differential value ΔHn is the third predetermined value A3 or greater, whether or not the differential value Δθxn is a fourth predetermined value A4 or greater, and whether or not the differential value Δθyn is a fifth predetermined value A5 or greater.

The first predetermined value A1 to the third predetermined value A3 are similar to the first predetermined value A1 to the third predetermined value A3 according to Embodiment 1. The fourth predetermined value A4 indicates a threshold value for determining the magnitude of the differential value Δθxn, or in other words, whether or not the amount of change in the first sight line angle θxn is large. The fifth predetermined value A5 indicates a threshold value for determining the magnitude of the differential value Δθyn, or in other words, whether or not the amount of change in the second sight line angle θyn is large.

When the detection signal processing unit 21 makes a negative determination (step S163, No), the process proceeds to step S165. A negative determination indicates that the differential value ΔLzn is determined to be less than the first predetermined value A1, the differential value ΔLxn is determined to be less than the second predetermined value A2, the differential value ΔHn is determined to be less than the third predetermined value A3, the differential value Δθxn is determined to be less than the fourth predetermined value A4, and the differential value Δθyn is determined to be less than the fifth predetermined value A5.

In step S165, the detection signal processing unit 21 sets each of the distance Lzn, the horizontal distance Lxn, the length Hn, the first sight line angle θxn, and the second sight line angle θyn to the specific value v1.

On the other hand, when the detection signal processing unit 21 makes a positive determination (step S163, Yes), the process proceeds to step S167. A positive determination indicates that the differential value ΔLzn is determined to be the first predetermined value A1 or greater, the differential value ΔLxn is determined to be the second predetermined value A2 or greater, the differential value ΔHn is determined to be the third predetermined value A3 or greater, the differential value Δθxn is determined to be the fourth predetermined value A4 or greater, or the differential value Δθyn is determined to be the fifth predetermined value A5 or greater.

In step S167, the detection signal processing unit 21 outputs data indicating the distance Lzn, the horizontal distance Lxn, the length Hn, the first sight line angle θxn, and the second sight line angle θyn to the transparency setting unit 23.

In step S169, the detection signal processing unit 21 increments the variable n by 1. In step S173, the detection signal processing unit 21 substitutes the value of the variable n into the number N of moving bodies HMn.

As described above with reference to FIG. 12, according to Embodiment 2, the distance Lzn, the horizontal distance Lxn, the length Hn, the first sight line angle θxn, and the second sight line angle θyn are computed on the basis of a detection result from the detection unit 13. “Computing the distance Lzn, the horizontal distance Lxn, the length Hn, the first sight line angle θxn, and the second sight line angle θyn” is one example of “deciding the distance Lzn, the horizontal distance Lxn, the length Hn, the first sight line angle θxn, and the second sight line angle θyn”.

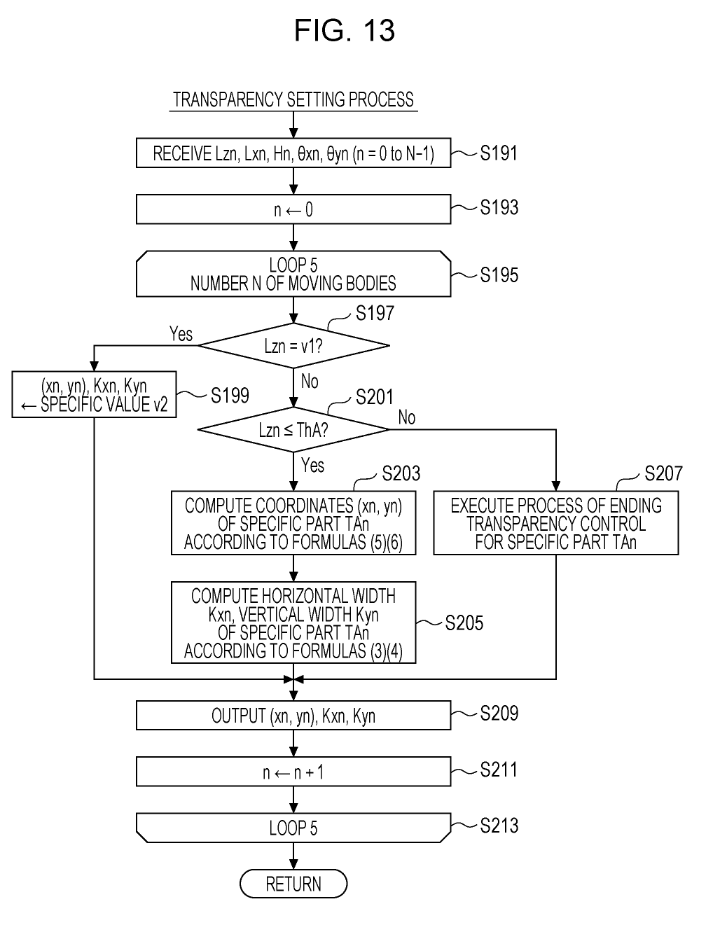

Next, FIGS. 3 and 13 will be referenced to describe step S3 of FIG. 5. FIG. 13 is a flowchart illustrating the transparency setting process in step S3 of FIG. 5. As illustrated in FIG. 13, the transparency setting process includes steps S191 to S213.

As illustrated in FIGS. 3 and 13, in step S191, the transparency setting unit 23 receives data indicating the distance Lzn, the horizontal distance Lxn, the length Hn, the first sight line angle θxn, and the second sight line angle θyn in correspondence with n=0 to (N−1) from the detection signal processing unit 21.

In step S193, the transparency setting unit 23 sets the variable n to zero. Additionally, the transparency setting unit 23 starts from n=0, repeats the process from step S195 to step S213 a number of times equal to the number N of moving bodies HMn, and exits the loop when the value of the variable n becomes “N”.

In step S197, the transparency setting unit 23 determines whether or not the distance Lzn is set to the specific value v1. When the transparency setting unit 23 makes a positive determination (step S197, Yes), the process proceeds to step S199. In step S199, the transparency setting unit 23 sets each of the coordinates (xn, yn), the horizontal width Kxn, and the vertical width Kyn of the specific part TAn to a specific value v2. Subsequently, the process proceeds to step S209.

On the other hand, when the transparency setting unit 23 makes a negative determination (step S197, No), the process proceeds to step S201.

In step S201, the transparency setting unit 23 determines whether or not the distance Lzn is the first threshold ThA or less.

When the transparency setting unit 23 makes a negative determination (step S201, No), the process proceeds to step S207.

In step S207, the transparency setting unit 23 executes a process of ending transparency control for the specific part TAn.

On the other hand, when the transparency setting unit 23 makes a positive determination (step S201, Yes), the process proceeds to step S203.

In step S203, the transparency setting unit 23 computes the coordinates (xn, yn) of the specific part TAn according to Formulas (5) and (6).

In step S205, the transparency setting unit 23 computes the horizontal width Kxn and the vertical width Kyn of the specific part TAn according to Formulas (3) and (4).

In step S209, the transparency setting unit 23 outputs data indicating the coordinates (xn, yn), the horizontal width Kxn, and the vertical width Kyn of the specific part TAn to the transparency processing unit 25. In step S211, the transparency setting unit 23 increments the variable n by 1.

As described above with reference to FIG. 13, according to Embodiment 2, when the amount of change in each of the distance Lzn, the distance Lxn, the height Hn, the first sight line angle θxn, and the second sight line angle θyn is small (No in step S163, Yes in step S197), step S203 and step S205 are skipped, and the coordinates (xn, yn), the horizontal width Kxn, and the vertical width Kyn are not computed. As a result, the processing load on the transparency setting unit 23 may be reduced.

### Embodiment 3

FIG. 3 and FIGS. 14A to 16 will be referenced to describe a display system 100 according to Embodiment 3 of the present disclosure. Embodiment 3 principally differs from Embodiment 2 in that when the moving body HM is positioned near the display panel 5, the display system 100 according to Embodiment 3 changes the position of the specific part TA without basing the change on the sight line SL. Hereinafter, the points in Embodiment 3 that are different from Embodiment 2 will be described mostly. Also, since the configuration of the display system 100 according to Embodiment 3 is similar to the configuration of the display system 100 according to Embodiment 1, FIG. 3 will be referenced where appropriate.

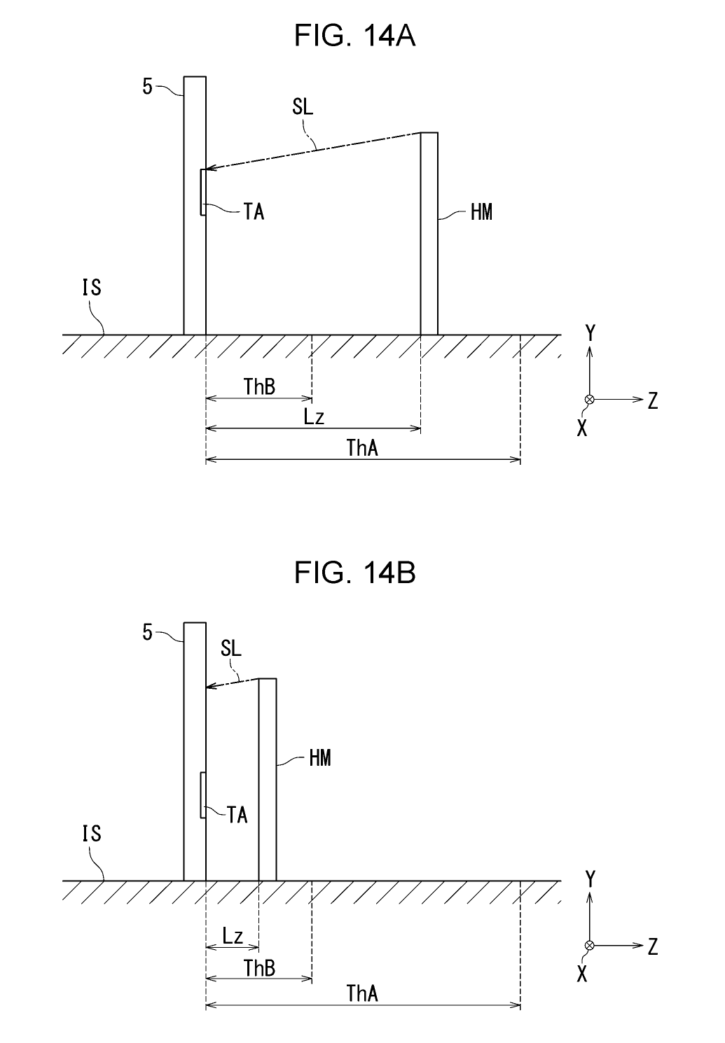

FIG. 14A is a diagram illustrating the specific part TA before the position change. FIG. 14B is a diagram illustrating the specific part TA after the position change.

As illustrated in FIGS. 3 and 14A, when the distance Lz between the moving body HM and the display panel 5 is less than or equal to the first threshold ThA and also greater than a second threshold ThB, the controller 9 computes the position of the specific part TA of the display panel 5 on the basis of at least the sight line SL of the moving body HM. The second threshold ThB is smaller than the first threshold ThA.

Additionally, as illustrated in FIGS. 3 and 14B, when the distance Lz is the second threshold ThB or less, the controller 9 changes the position of the specific part TA of the display panel 5. Specifically, the controller 9 changes the position of the specific part TA of the display panel 5 to a predetermined position U (not illustrated) input by the user. The distance Lz being the second threshold ThB or less indicates that the moving body HM is positioned near the display panel 5. “Near” means, for example, a range AR (not illustrated) in which a hand of a human being acting as the moving body HM reaches the display panel 5, or a range slightly larger than the range AR.

As described above with reference to FIGS. 14A and 14B, according to Embodiment 3, when the distance Lz is the second threshold ThB or less, the position of the specific part TA of the display panel 5 is changed. Consequently, when the human being acting as the moving body HM is positioned near the display panel 5, the position of the specific part TA may be changed to guide the sight line of the human being to the specific part TA after the position change. For example, the position of the specific part TA may be changed to a position opposite a specific object (for example, a featured product) positioned on the back side of the display panel 5, and the sight line of the human being may be guided through the specific part TA after the position change to the specific object. Otherwise, Embodiment 3 exhibits effects similar to Embodiment 2.

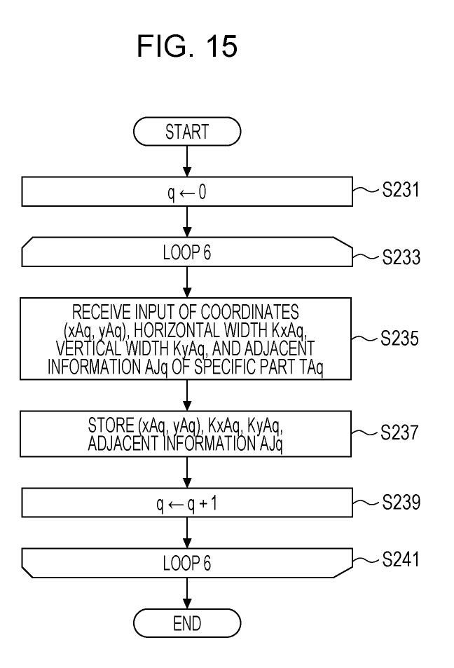

Next, FIGS. 3 and 15 will be referenced to describe a process when the input of the predetermined position U is received from a user. FIG. 15 is a flowchart illustrating a process when the display device 1 receives input from a user. As illustrated in FIG. 15, the process includes steps S231 to S241.

As illustrated in FIGS. 3 and 15, in step S231, a variable q is set to zero. Additionally, starting from q=0, the process from step S233 to step S241 is repeated a number of times equal to a predetermined number Q, and the loop is exited when the value of the variable q becomes “Q”. The predetermined number Q indicates a maximum number of moving bodies HMn, and is predetermined.

In step S235, the input unit 17 receives from a user the input of any or all of the information from among coordinates (xAq, yAq) of a specific part TAq, a horizontal width KxAq, a vertical width KyAq, and adjacent information AJq with respect to the specific part TAq. Subsequently, an input signal including any or all of the information from among the coordinates (xAq, yAq), the horizontal width KxAq, the vertical width KyAq, and the adjacent information AJq is output to the input information processing unit 18.

The coordinates (xAq, yAq) indicate the predetermined position U of the specific part TAq. The horizontal width KxAq and the vertical width KyAq indicate the size of the specific part TAq. The adjacent information AJq indicates an image or symbol to display adjacent to the specific part TAq. The symbol may be letters (for example, the word “Bargain”), numbers, or a mark. The adjacent information AJq functions as a decorative image or a decorative symbol for decorating the specific part TAq, for example.

For example, the display panel 5 displays an on-screen display (OSD) menu. Subsequently, the coordinates (xAq, yAq), the horizontal width KxAq, the vertical width KyAq, and/or the adjacent information AJq are input through the input unit 17 by input and a control command with respect to the OSD menu. Additionally, for example, the input unit 17 may also be a removable medium such as USB memory. Furthermore, the removable medium may be connected to the display device 1, and the coordinates (xAq, yAq), the horizontal width KxAq, the vertical width KyAq, and/or the adjacent information AJq may be input from the removable medium.

In step S237, from the input signal output by the input unit 17, the input information processing unit 18 extracts information included in the input signal from among the coordinates (xAq, yAq), the horizontal width KxAq, the vertical width KyAq, and the adjacent information AJq. Subsequently, the input information processing unit 18 converts the data format of the extracted information to a data format usable by the transparency setting unit 23. In addition, the input information processing unit 18 controls the storage unit 15 to store the information in the converted data format. As a result, the storage unit 15 stores information included in the input signal from among the coordinates (xAq, yAq), the horizontal width KxAq, the vertical width KyAq, and the adjacent information AJq.

As described above with reference to FIG. 15, according to Embodiment 3, through the input unit 17, the user is able to set the position and size of the specific part TAq when the distance Lzq between the moving body HMq and the display panel 5 is the second threshold ThB or less to a desired position and size. For example, the user is able to set the position and size of the specific part TAq to face opposite a desired object among the objects (for example, products) housed in the body 3.

Also, according to Embodiment 3, the storage unit 15 stores adjacent information AJq. Consequently, the controller 9 controls the display panel 5 to display the adjacent information AJq at a position adjacent to the specific part TAq. As a result, the display panel 5 displays the adjacent information AJq adjacent to the specific part TAq. Since the adjacent information AJq is displayed, the sight line of a human being may be guided to the specific part TAq more effectively. Additionally, the sight line of a human being may be guided more effectively to an object (for example, a product) positioned on the back side of the display panel 5 opposite the specific part TAq.

Next, FIGS. 5, 8, 9, and 12 will be referenced to describe a control method executed by the controller 9 of the display device 1. As illustrated in FIG. 5, the control method according to Embodiment 3 includes steps S1 to S7, similarly to Embodiment 1. Step S1 according to Embodiment 3 is similar to the detection signal process illustrated in FIG. 12. In step S3, the transparency setting unit 23 computes the position and size of the specific part TA on the basis of the distance Lz, the length H, the position P, and the sight line SL, or alternatively, sets the position and size of the specific part TA to a position and size input by the user. Step S5 and step S7 according to Embodiment 3 are similar to the transparency process illustrated in FIG. 8 and the panel driving process illustrated in FIG. 9, respectively.

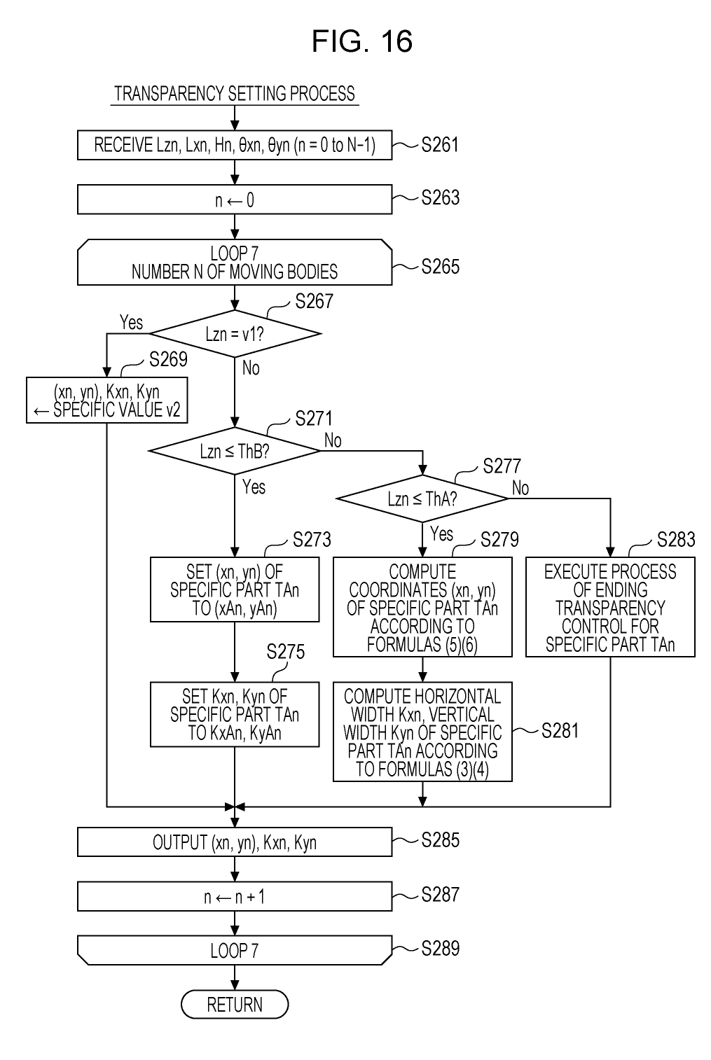

Next, FIGS. 3 and 16 will be referenced to describe step S3 of FIG. 5. FIG. 16 is a flowchart illustrating the transparency setting process in step S3 of FIG. 5. As illustrated in FIG. 16, the transparency setting process includes steps S261 to S289.

As illustrated in FIGS. 3 and 16, in step S261, the transparency setting unit 23 receives data indicating the distance Lzn, the horizontal distance Lxn, the length Hn, the first sight line angle θxn, and the second sight line angle θyn in correspondence with n=0 to (N−1) from the detection signal processing unit 21.

In step S263, the transparency setting unit 23 sets the variable n to zero. Additionally, the transparency setting unit 23 starts from n=0, repeats the process from step S265 to step S289 a number of times equal to the number N of moving bodies HMn, and exits the loop when the value of the variable n becomes “N”.

In step S267, the transparency setting unit 23 determines whether or not the distance Lzn is set to the specific value v1. When the transparency setting unit 23 makes a positive determination (step S267, Yes), the process proceeds to step S269. In step S269, the transparency setting unit 23 sets each of the coordinates (xn, yn), the horizontal width Kxn, and the vertical width Kyn of the specific part TAn to the specific value v2. Subsequently, the process proceeds to step S285.

On the other hand, when the transparency setting unit 23 makes a negative determination (step S267, No), the process proceeds to step S271.

In step S271, the transparency setting unit 23 determines whether or not the distance Lzn is the second threshold ThB or less.

When the transparency setting unit 23 makes a positive determination (step S271, Yes), the process proceeds to step S273.

In step S273, the transparency setting unit 23 sets the coordinates (xn, yn) of the specific part TAn to the coordinates (xAn, yAn) stored in step S237 of FIG. 15.

In step S275, the transparency setting unit 23 sets the horizontal width Kxn and the vertical width Kyn of the specific part TAn to the horizontal width KxAn and the vertical width KyAn stored in step S237 of FIG. 15, respectively.

On the other hand, when the transparency setting unit 23 makes a negative determination (step S271, No), the process proceeds to step S277.

Steps S277 to S283 are similar to steps S201 to S207 in FIG. 13, respectively.

In step S285, the transparency setting unit 23 outputs data indicating the coordinates (xn, yn), the horizontal width Kxn, and the vertical width Kyn of the specific part TAn to the transparency processing unit 25. In step S287, the transparency setting unit 23 increments the variable n by 1.

The above describes embodiments of the present disclosure with reference to the drawings. However, the present disclosure is not limited to the above embodiments, and may be carried out in various modes in a range that does not depart from the gist of the present disclosure (for example, (1) to (3) illustrated below). Also, various modifications of the present disclosure are possible by appropriately combining the multiple structural elements disclosed in the above embodiments. For example, several structural elements may be removed from among all of the structural elements illustrated in the embodiments. Furthermore, structural elements across different embodiments may be combined appropriately. The drawings schematically illustrate each of the structural elements as components for the sake of understanding, but in some cases, the thicknesses, lengths, numbers, intervals, and the like of each illustrated structural element may be different from actuality for the sake of convenience in the creation of the drawings. Also, the materials, shapes, dimensions, and the like of each structural element illustrated in the above embodiments are one example and not particularly limiting, and various modifications are possible within a range that does not depart substantially from the effects of the present disclosure.

(1) In Embodiments 1 to 3, as long as at least the distance Lz is detectable, the installation position of the detection unit 13 is not limited to being outside the display device 1. For example, the display device 1 may be provided with the detection unit 13, and the detection unit 13 may be installed in the display device 1. Also, as long as the distance Lz, the horizontal distance Lx, the length H, the first sight line angle θx, and the second sight line angle θy are computable, the configuration is not limited to the controller 9 computing the distance Lz, horizontal distance Lx, the length H, the first sight line angle θx, and the second sight line angle θy. For example, the detection unit 13 may also compute any or all of the distance Lz, the horizontal distance Lx, the length H, the first sight line angle θx, and the second sight line angle θy on the basis of a detection result from the detection unit 13. In this case, the controller 9 acquires any or all of the distance Lz, the horizontal distance Lx, the length H, the first sight line angle θx, and the second sight line angle θy from the detection unit 13.

(2) In Embodiments 1 to 3, the shape of the specific part TA is not limited to a rectangular shape, and may be set to any shape. For example, the shape of the specific part TA may be set to a shape corresponding to the shape of an object (for example, a product) housed in the body 3. For example, the shape of the specific part TA may be set to a shape corresponding to an image displayed on the display panel 5. For example, in Embodiment 3, the input unit 17 is able to receive the input of shape information about the specific part TA from the user. Subsequently, the transparency setting unit 23 sets the shape of the specific part TA on the basis of the shape information. Note that to make the drawings easy to understand, an outline of the specific part TA is indicated with solid lines, but in actuality, solid lines indicating the outline are not displayed. However, the outline of the specific part TA may be displayed in a specific color. Note that the body 3 may also not be provided.

(3) In Embodiment 3, when the distance Lz becomes the second threshold ThB, the detection unit 13 (for example, the imaging unit 29 or a touch panel) may detect a gesture by a human being acting as the moving body HM. Subsequently, the controller 9 may set the position of the specific part TA according to the gesture.

The present disclosure provides a display device, a control method, and a non-transitory computer-readable recording medium, and has industrial applicability.

The present disclosure contains subject matter related to that disclosed in Japanese Priority Patent Application JP 2017-217073 filed in the Japan Patent Office on Nov. 10, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display panel that displays an image; and
a controller that controls the display panel when a distance between a moving body able to move and be still and the display panel is a first threshold or less, such that at least a part of the display panel is see-through.

2. The display device according to claim 1, wherein
the at least a part of the display panel is a specific part of the display panel.

3. The display device according to claim 2, wherein
the controller decides a size of the specific part of the display panel on a basis of the distance.

4. The display device according to claim 2, wherein
the controller decides a position of the specific part of the display panel on a basis of at least one of a length in a vertical direction of the moving body and a position of the moving body with respect to the display panel.

5. The display device according to claim 2, wherein
the controller decides a position of the specific part of the display panel on a basis of a sight line of the moving body.

6. The display device according to claim 2, wherein
when the distance is a second threshold or less, the controller changes a position of the specific part of the display panel, and
the second threshold is smaller than the first threshold.

7. The display device according to claim 2, wherein
the controller
determines whether or not the distance is the first threshold or less with respect to each of a plurality of moving bodies, and
in a case of determining that the distance is the first threshold or less for each of two or more moving bodies among the plurality of moving bodies, the controller sets the specific part in correspondence with each of the two or more moving bodies on the display panel.

8. The display device according to claim 1, wherein
the distance is decided on a basis of a detection result of a detection unit that detects the moving body.

9. A control method comprising:
determining whether or not a distance between a moving body able to move and be still and a display panel is a threshold or less; and
controlling the display panel when the distance is determined to be the threshold or less, such that at least a part of the display panel is see-through.

10. A non-transitory computer-readable recording medium storing a computer program causing a computer to execute a process comprising:
determining whether or not a distance between a moving body able to move and be still and a display panel is a threshold or less; and
controlling the display panel when the distance is determined to be the threshold or less, such that at least a part of the display panel is see-through.
